(19) United States
(12) Patent Application Publication
(10) Pub. No.: US 2024/0226802 A1
(43) Pub. Date: Jul. 11, 2024

(54) INTEGRATED THIN FILM COMPOSITE MEMBRANES FOR CO2 SEPARATION AND METHODS OF MAKING THE SAME

(71) Applicant: UCHICAGO ARGONNE, LLC, Chicago, IL (US)

(72) Inventors: Yuepeng Zhang, Naperville, IL (US); Jungkuk Lee, Bolingbrook, IL (US); Wei Chen, Naperville, IL (US); Shiyu Hu, Willowbrook, IL (US); Andrew Erwin, La Grange, IL (US); Feng Gao, Bolingbrook, IL (US)

(21) Appl. No.: 18/410,456

(22) Filed: Jan. 11, 2024

Related U.S. Application Data
(60) Provisional application No. 63/438,416, filed on Jan. 11, 2023.

(51) Int. Cl. B01D 53/22; B01D 67/00; B01D 69/02; B01D 69/12; B01D 69/14; B01D 71/38; B01D 71/68; B01D 71/70; B01D 71/82

(52) U.S. Cl. CPC B01D 53/228; B01D 67/00791; B01D 67/00793; B01D 69/02; B01D 69/12; B01D 69/1216; B01D 69/14111; B01D 69/142; B01D 69/147; B01D 69/148; B01D 71/381; B01D 71/68; B01D 71/701; B01D 71/82; B01D 2257/504; B01D 2257/80; B01D 2323/36; B01D 2325/022; B01D 2325/04; B01D 2325/12

(57) ABSTRACT

A CO₂ separation membrane can include a CO₂-philic layer comprising one or more mobile CO₂ carriers and one or more immobile CO₂ carriers and a blended CO₂-permeable and CO₂-selective matrix that hosts the immobile or mobile CO₂ carriers and porous nanostructures that adsorb water vapors. The CO₂-philic layer can be disposed upstream of the CO₂-permeance layer such that a flow of source gas to be separate enters the membrane from a feed side at which the CO₂-philic layer is present and CO₂ exits the membrane at a permeate side after passing through both the CO₂-philic layer and the CO₂-permeance layer.

### CROSS-REFERENCE TO RELATED APPLICATION

The benefit of priority to U.S. Provisional Patent Application No. 63/438,416 filed Jan. 11, 2023, the disclosure of which is incorporated herein by reference in its entirety FIELD

The disclosure relates to membranes for CO₂ separations and methods of making the same.

### BACKGROUND

Process-related emission from calcination accounts for the major CO₂ emissions from heavy industry such as cement and steelmaking plants in the U.S. and cannot be reduced by switching fossil fuels to renewable energy. The adoption of carbon capture utilization and storage (CCUS) technologies is crucial to decarbonize cement industry. Adsorption, absorption, and membrane processing are primary CO₂ capture technologies used in industry. The conventional adsorption or absorption processes require the use of energy intensive treatment facilities for sorbent and acid, which is not only slow, but also consumes a large amount of organic solvent for sorbent regeneration.

By comparison, a membrane-based process is compact and has less energy and water usage, but its treatment capacity is lower than the adsorption process due to permeability and selectivity trade-off. CO₂ transportation within polymeric membranes is usually through solution-diffusion, which depends on the polymer material's intrinsic properties. High permeability has been observed for perfluoropolymers, thermally arranged polymers, and iptycene-containing polymer materials. However, this type of gas diffusion membrane has limitations in CO₂ selectivity. The CO₂ interactive materials, such as amine-functionalized materials (polyvinylamine, polyethyleneimine, polyallylamine materials) and ionic liquid have been shown to have improved CO₂ selectivity, but their CO₂ permeabilities were relatively low. Such limitations of current conventional membrane technology, as well as the high operation and capital costs required to implement the technologies has rendered them of little commercial value at manufacturing scale.

### SUMMARY

CO₂ separation membranes and processes of the disclosure can provide low-cost, high-throughput on-site post combustion CO₂ capture at manufacturing sites. The membranes and processes of the disclosure can be modular and compact. This can advantageously allow the technology to readily be incorporated into any CO₂ intensive manufacturing processes, both at new factories and as retrofits to existing processes.

Commercially available membranes show relatively low CO₂ selectivity. Current state-of-the-art membranes demonstrate improved selectivity, but cannot meet the CO₂ permeance and cost requirements for commercially viable use.

A CO₂ separation membrane in accordance with the disclosure can include a CO₂-philic layer comprising one or more mobile CO₂ carriers and one or more immobile CO₂ carriers, a blended CO₂-permeable and CO₂-selective polymer matrix, and water adsorption nanostructures. The membrane can further include a CO₂-permeance layer. The CO₂-philic layer is disposed upstream of the CO₂-permeance layer such that a flow of source gas to be separate enters the membrane from a feed side at which the CO₂-philic layer is present and CO₂ exits the membrane at a permeate side after passing through both the CO₂-philic layer and the CO₂-permeance layer.

### BRIEF DESCRIPTION OF THE DRAWINGS

FIG. 1 is a schematic illustration of a CO₂ capture membrane in accordance with the disclosure having a bilayer CO₂-philic layer.

FIG. 2 is a schematic illustration of a CO₂ capture membrane in accordance with the disclosure having a single composite CO₂-philic layer.

FIG. 3 is a schematic illustration of a CO₂ capture membrane in accordance with the disclosure having a composition gradient in the CO₂-philic layer.

FIGS. 4A and 4B are scanning electron microscopy (SEM) images of a CO₂ capture membrane in accordance with the disclosure containing nanofiber structures.

FIGS. 5A and 5B are plan-view and cross-sectional SEM images of a slot-die coated membrane in accordance with the disclosure having a 350 nm thin amine functionalized CO₂-philic layer and porous CO₂-permeance layer.

FIG. 6A is a scanning transmission electron microscopy (STEM) high angle annular dark field (HAADF) image and energy dispersive x-ray (EDX) elemental mapping of porous nanostructures made using a PAA method.

FIG. 6B is a STEM-HAADF image and EDX elemental mapping of porous nanostructures made using a CTAB method.

FIG. 7A is an XPS N 1 s spectra of NH₂-functionalized porous nanostructures.

FIG. 7B is an XPS N 1 s spectra of NH₂-functionalized graphene nanoplatelets.

FIG. 8 is a photograph of membranes in accordance with the disclosure.

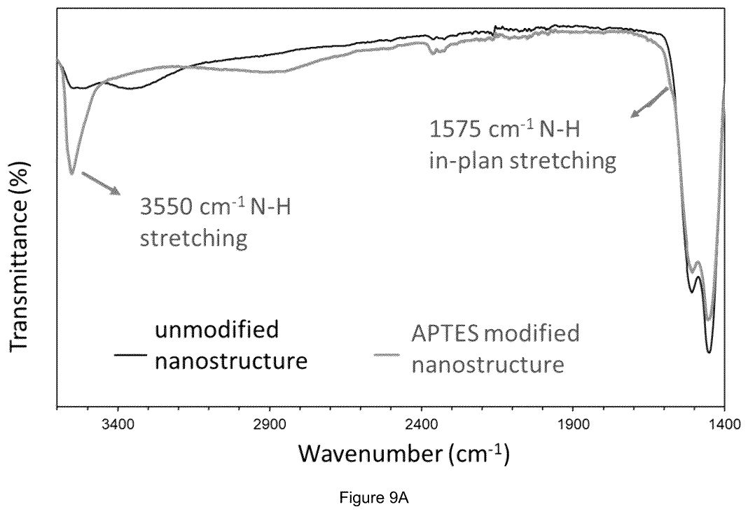

FIGS. 9A and 9B are Fourier transform infrared (FTIR) spectra of APTES and GPS modified oxide nanostructures.

FIG. 10 is a schematic illustration of a CO₂ capture membrane in accordance with the disclosure having a gutter layer and a cap layer.

### DETAILED DESCRIPTION

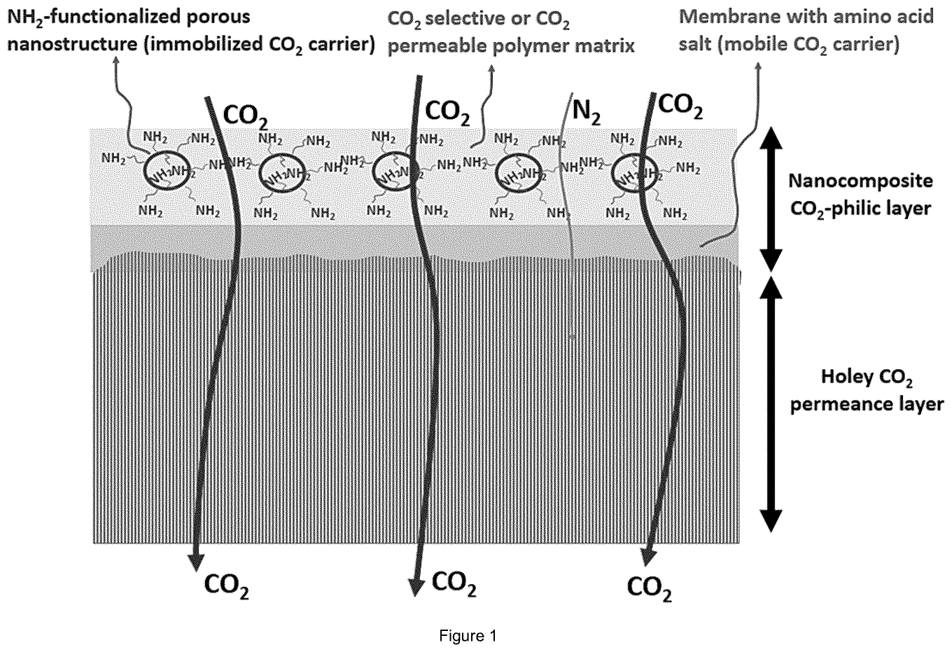

Membranes in accordance with the disclosure have been observed to have improved CO₂/N₂ selectivity as well as CO₂ permeance. The membranes utilize a composite structure having one or more CO₂-philic layer, and one or more CO₂ permeable layers. Referring to FIG. 1, the one or more CO₂-philic layers are arranged upstream of the one or more CO₂ permeance layers. The selective CO₂ transport of the membranes of the disclosure is achieved mainly through the CO₂-philic layer(s). High CO₂ permeance is attributed not only to the hybrid structure of the membrane (e.g., submicrometer thickness of the CO₂-philic layer) but also to the high CO₂ permeability of the CO₂-philic layer itself. The benefit associated with a CO₂-philic layer with high CO₂ permeability is that the thin film requirement can be loosened, which makes membrane fabrication and scale up less challenging. For example, the possibility to form pin hole defects in a thin film (<1 μm) deposited on a commonly used porous substrate is much higher than a thick film (e.g., >1 μm). With both improved CO₂ selectivity and permeability, this design advantageously avoids the trade-off challenge of selectivity and permeance of single materials and the manufacturing challenges of defects in thin membranes.

The CO₂-philic layer(s) and CO₂ permeable layer(s) can be crosslinked to enhance the structural stability and mechanical strength of the composite membranes. The crosslinker can be, for example, trimethylolpropane tris(2-methyl-1-aziridinepropionate) (TATM), diethylenetriamine (DETA), triethylenetetramine (TETA), perfluorinated toluene diisocyanate (PFTDI), but not limited to these materials. The use of crosslinker depends on the materials of CO₂-philic layer(s) and CO₂ permeable layer(s). Crosslinking can be achieved, for example, by ultraviolet (UV) curing, thermal curing, electron beam curing, and other chemical bonding methods. The CO₂-philic layer(s) contains both mobile, immobile amine-based CO₂ carriers, and nanostructure. The CO₂-philic layer can have a thickness of about 10 nm to about 500 μm. With immobile amine-based carriers, CO₂ and H₂O from the feed gas side can interact with the amine groups in the membrane to form bicarbonate ion (HCO₃⁻), which can release CO₂ at the permeate side of the membrane. They can also form propylammonium carbamate ion pair [R—NH—COO][NH₃R] when the amine density is high, which can better facilitate CO₂ interaction. Mobile carriers such as amino acid salts react with CO₂ through zwitterionic mechanism. The amino acid salt is first protonated with H₂O and then interacts with CO₂ to form carbamate ions (NCOO—), which transports CO₂ from the feed side to the permeate side in a cycled binding-release-regeneration loop. The nanostructure such as zeolite and metal organic framework (MOF) absorbs H₂O from the feed gas sides and hence increase H₂O content in the membrane, facilitating amino-group protonation and CO₂ interaction and transport.

The mobile amine-based CO₂ carriers can be amino acid salts, amine-containing small molecules, amine-containing ionic liquids, and caronic anhydrase (CA), but are not limited to these materials. Suitable amino acid salts include, but are not limited to, Proline with potassium, potassium glycinate, lithium glycinate, potassium argininate, and piperazine glycinate. The amine-containing small molecules include ethanediamine (EDA), piperazine (PIP), monoethanolamine (MEA) and diethanol amine (DEA). Amine containing ionic liquids include, but are not limited to tetrabutylphosphonium prolinate ([P₄₄₄₄][Pro]) and Triethyl(2-methoxymethyl) phosphonium Indazolide [P₂₂₂₍₁₀₁₎][Inda].

Mobile carriers, such as amino acid salts can diffuse within matrix polymers and often show higher CO₂ permeance than immobilized amine-functionalized CO₂ carriers.

The immobile carriers can be amine-impregnated nanostructures, and amine-containing ionic liquids. Hollow or porous nanostructures are preferred due to their large surface area and pore channel effect. For example, the nanostructures can be one or more of porous silica nanospheres, hollow oxides nanospheres, porous TiO₂ nanoparticles, carbon nanotubes, graphene oxides. They can also be molecular sieves such as zeolite, covalent organic frameworks (COF), and metal organic framework (MOF) structures. Additionally, these porous nanostructures can be used without amine functionalization to adsorb water vapors and facilitate amine-protonation and interaction with CO₂. The nanostructures can have an effective average diameter of about 10 nm to about 1 μm. The pore size of the nanostructures or cavity size of the molecular sieves can be between 0.4 nm and 1 μm. The amine-containing ionic liquids include, but not limited to poly(1-vinyl-3-ethylimidazolium glycinate) (Poly([Veim] [Gyl]), Amine-crosslinked epoxide-amine poly(imidazolium) poly-[Im][TFSI]/1-ethyl-3-methylimidazolium dicyanamide ([EMIM] [DCA]).

The nanostructures can be optionally covalently linked to host polymers. For example, the nanostructures can be covalently linked through functionalization by plasma surface modification, grafting functional polymer molecules, and silanization. The surface functional polymer molecules and silanization agent can include, for example, but are not limited to, 3-glycidyloxypropyl trimethoxysilane (GPS), (3-Aminopropyl)triethoxysilane (APTES), Vinyltriethoxysilane (VTES), Phenyltrimethoxysilane (PTMS), (3-Methacryloxypropyl)trimethoxysilane (MPS).

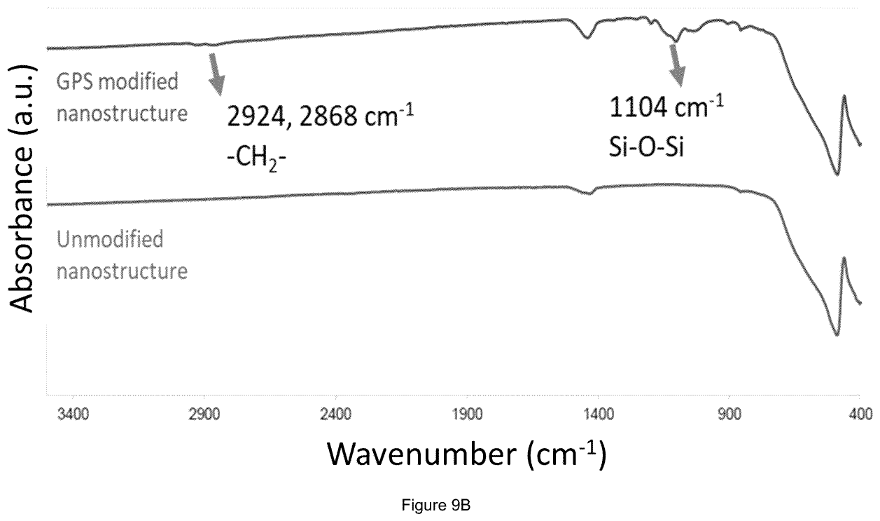

FIG. 9A shows Fourier transform infrared (FTIR) spectra of unmodified oxide nanostructure and APTES modified oxide nanostructure. The peaks at 3550 and 1575 cm⁻¹ can be attributed to N—H stretching vibration, indicating that the surface of oxide nanoparticle is successfully modified with APTES. FIG. 9B shows FTIR spectra of GPS modified nanostructure. The peaks at 1104 cm⁻¹ is assigned to Si—O—Si, and 2924, 2868 cm⁻¹ is attributed to —CH₂— vibration, confirming the presence of GPS on the surface of oxide nanostructure.

Alternatively or additionally, the nanostructures can be tightly captured by the host polymers through host polymer crosslinking using small molecule activators or UV light after membrane casting. The crosslinker can be, for example, trimethylolpropane tris(2-methyl-1-aziridinepropionate) (TATM), diethylenetriamine (DETA), trimethylolpropane (TMP), trimethylolpropane trimethacrylate (TMPTMA), hexamethylene diisocyanate (HDI), but not limited to these materials.

The host polymer can be a rubbery polymer, a polyamine, poly(ionic liquid)-type materials or blended matrix of those. Rubbery polymers can include, but are not limited to polydimethylsiloxane and polyamine/polyether elastomers such as Pebax® (ARKEMA). Polyamides can include polyvinylamine (PVAm), poly(ethyleneimine (PEI), poly(allylamine) (PAA), polyamidoamine (PAMAM) dendrimer, and chitosan. For example, the host polymer can be PVA-PEI. Poly(ionic liquid)-type materials can include Poly([Veim] [Gyl]), Amine-crosslinked poly-[Im][TFSI] epoxy resin/[Emim] [DCA], [P₄₄₄₄][Pro] and [P₂₂₂₁₀₁][Inda].

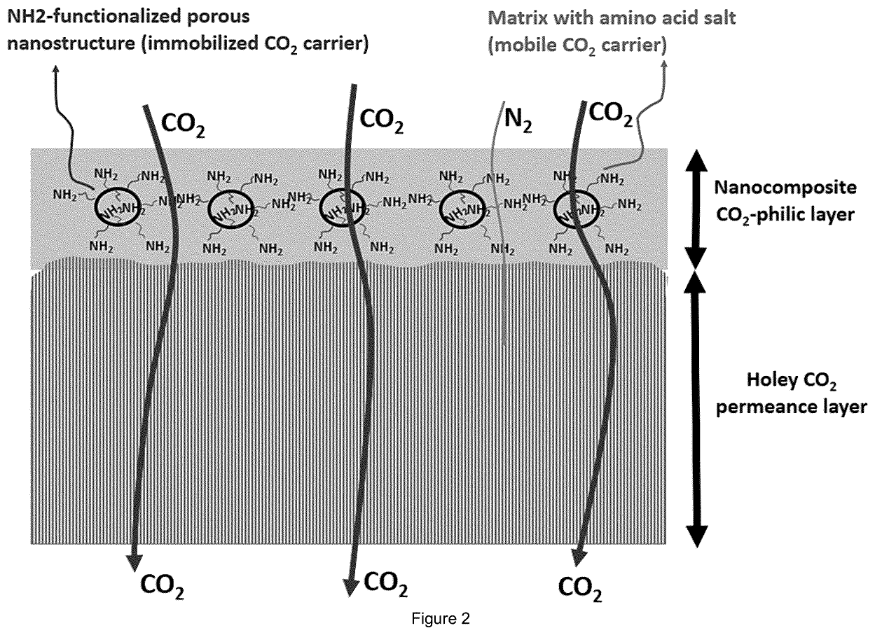

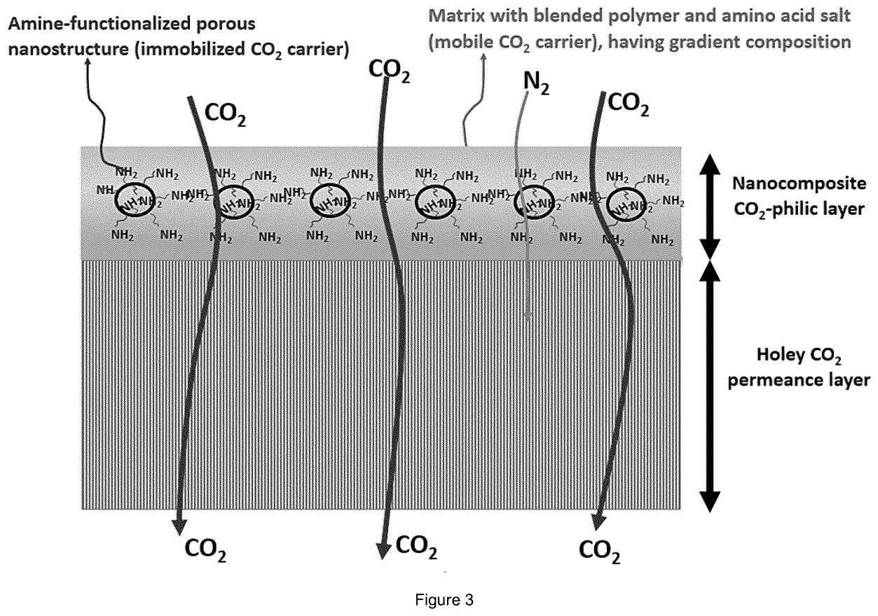

The CO₂-philic layer can have a multi-layer structure. For example, the immobile and mobilized CO₂ carriers can be present in separate layers, such as shown in FIG. 1. Referring to FIG. 2, the CO₂-philic layer can alternatively have a composite structure in which the mobile and immobile carriers are located in a single layer. As a further alternative, as shown in FIG. 3, the CO₂-philic layer can have a gradient structure with one or both of a concentration of mobile and immobile carriers being present in a gradient concentration. For example, the CO₂-philic layer can have a gradient concentration of mobile CO₂ carriers with increasing concentration of the mobile CO₂ carriers from the feed side to the permeate side of the membrane; and/or a gradient concentration of immobile CO₂ carriers, with decreasing concentration of immobile CO₂ carriers from the feed side to the permeate side of the membrane. The concentration of both mobile and immobile carrier can be range of 5 to 90% in the CO₂-philic layer. In addition, the polymer matrix that incorporates immobilized CO₂ carrier or mobile CO₂ carrier can contain two or more blended polymers and/or have a gradient polymer composition.

Where the CO₂-philic layer is provided as a multiple layer structure with the mobile and immobile CO₂ carriers separated in different layers of the multilayer structure, each individual layer can have a thickness of about 10 nm to about 500 μm.

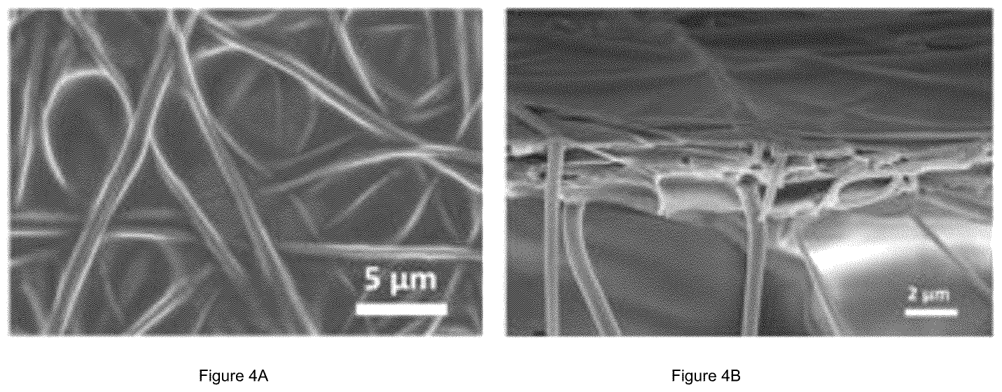

The CO₂-permeance layer can be an anisotropic nanofiltration or ultrafiltration membrane. The CO₂-permeance layer can serve as a support layer. The CO₂-permeance layer can have a thickness of about 10 μm to about 1000 μm. The CO₂-permeance layer can have an average pore size of about 1 nm to about 10 μm. The CO₂ permeance layer can be, for example, one or more of polymeric materials, such as, polyethersulfone (PES), polytetrafluoroethylene (PTFE), cellulose acetate, mixed cellulose ester (MCE), polycarbonate (PC), polyvinylidene fluoride (PVDF), nylon. Use of other polymer materials that can form porous structures are also contemplated herein. The CO₂ permeance layer can be, for example, one or more ceramic materials, such as alumina (Al₂O₃), zirconia (ZrO₂), titania (TiO₂), silicon carbide (SiC), and glassy materials. In another case, the CO₂ permeance layer can be made of metals or alloys, such as aluminum, stainless steel, and nickel-titanium. This layer can be fabricated by phase inversion induced immersion precipitation, non-solvent induced phase separation, three dimensional (3D) printing, extrusion, molding, casting, powder bed fusion, binder jetting, vat photopolymerization, stereolithography, or other similar techniques. The CO₂-permeance layer can have uneven microstructures across thickness direction, e.g., the average pore size or pore morphology is different among the top, middle, and bottom sections of the permeance layer. Different microstructures provide different tortuous paths for gas molecules to travel, leading to different gas transport mechanism. The surface microstructure of the permeance layer also influences deposition, adhesion, and defect of the CO₂-philic layer, which locates on top of the permeance layer. The CO₂-permeance layer can be, for example, a porous nano- or micrometer fibrous membrane with large or small fiber diameter, pore size, and porosity, such as shown in FIG. 4. Fabrication of nanofibrous membranes can be achieved by a variety of known methods, such as sol gel casting, drop casting, blade casting, spin coating, slot-die coating, screen printing, ink jet printing, aerosol jet printing, flexographic printing, gravure coating or printing, electrospinning, electrospraying, melt blowing, melt spinning, aerosol spray, or other similar techniques. The CO₂-permeance layer can be non-planar or even hollow as in the case of hollow fiber membranes.

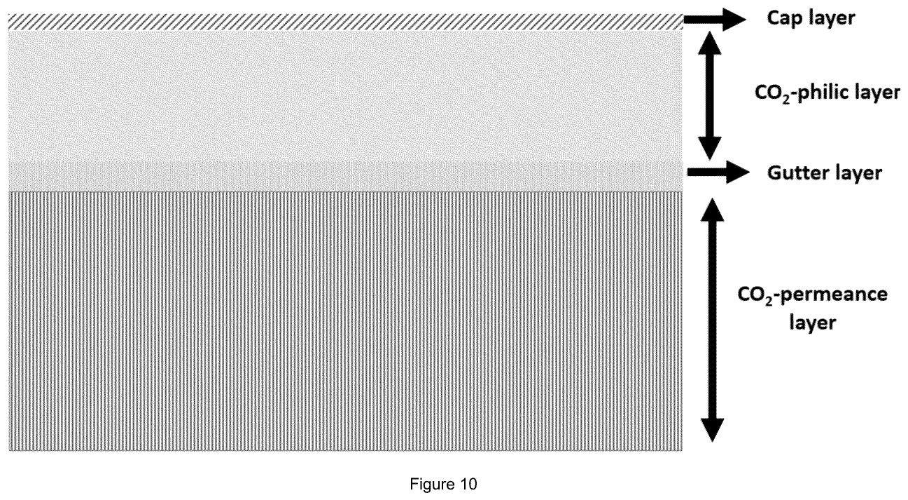

The membranes of the disclosure can have a gutter layer disposed between the CO₂-philic layer and the CO₂-permeance layer. The gutter layer can be one or more of rubbery polymers (such as PDMS, Pebax, PVA, polybutadiene, and chloroprene polymers), fluorinated polymers (such as fluoroelastomer, polytetrafluoroethylene (PTFE)), and glassy polymers such aspoly(1-(trimethylsilyl)-1-propyne) (PTMSP), and/or blend of two or more of those. The gutter layer can have a thickness of about 10 nm to about 500 μm. The membrane of the disclosure can have a cap layer disposed on top of the CO₂-philic layer that helps defects such as pin holes. The cap layer can be one or more of rubbery polymers (such as PDMS, Pebax, PVA, polybutadiene, and chloroprene polymers), fluorinated polymers (such as fluoroelastomer, polytetrafluoroethylene (PTFE)), and glassy polymers such aspoly(1-(trimethylsilyl)-1-propyne) (PTMSP), and/or blend of two or more of those. The cap layer can have a thickness of about 10 nm to about 500 μm. The gutter layer and cap layer can be cross-linked to the neighboring layers using cross-linkers and curing methods like the ones described previously. FIG. 10 illustrates a composite CO₂ separation membrane that contains gutter and cap layers.

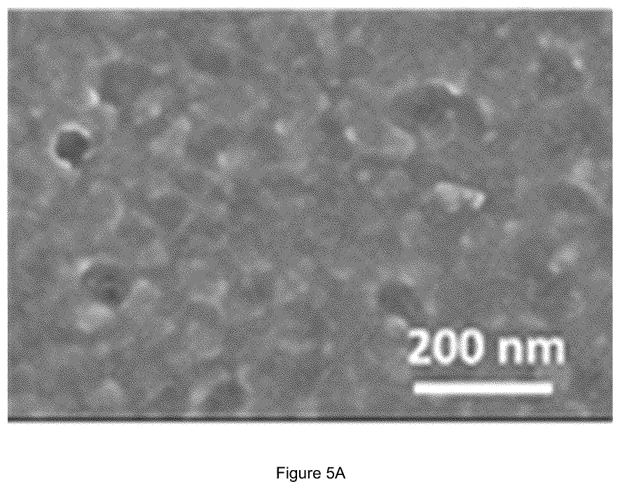

FIGS. 4A and 4B are scanning microscopy images of a composite membrane containing a nanofiber-poly(ionic liquid) composite CO₂-philic layer and a Nylon CO₂-permeance layer. FIGS. 5A and 5B show a membrane in accordance with the disclosure having a 350 nm thin CO₂-philic layer on a porous polyethersulfone (PES) CO₂-permeance layer.

Methods of forming membranes of the disclosure can include coating CO2-philic layer precursor onto a CO₂-permeance layer. Membranes in accordance with the disclosure can be used using various deposition methods to coat a CO₂-philic layer precursor onto the CO₂-permeance layer. For example, the CO₂-philic layer precursor can be coated by dip-coating, spin-coating, electro-spraying, gravure coating, slot-die coating, and blade coating. For example, a roll-to-roll slot-die coating system equipped with in-line drying and curing units such as UV curing lamps, two zone dry air furnace and infrared lamps can be used. Coated membrane material curing can be achieved through a variety of thermal treatments including isothermal curing, UV irradiation, electron beam irradiation, microwave heating, RF curing, or a combination of several treatments in stage.

The CO₂-philic precursor can include the mobile and immobile carriers, thereby allowing the mobile and immobile carriers to be coated in a single coating step. Alternatively, the mobile and immobile carriers can be provided in separate precursors, for example first and second precursors, can be prepared for the mobile and immobile carriers. The separate precursors can be coated sequentially to form a multilayer structure. The separate precursors can be coated sequentially or simultaneously to form gradient concentration structures. Any suitable solvents can be used in preparing the coating solutions.

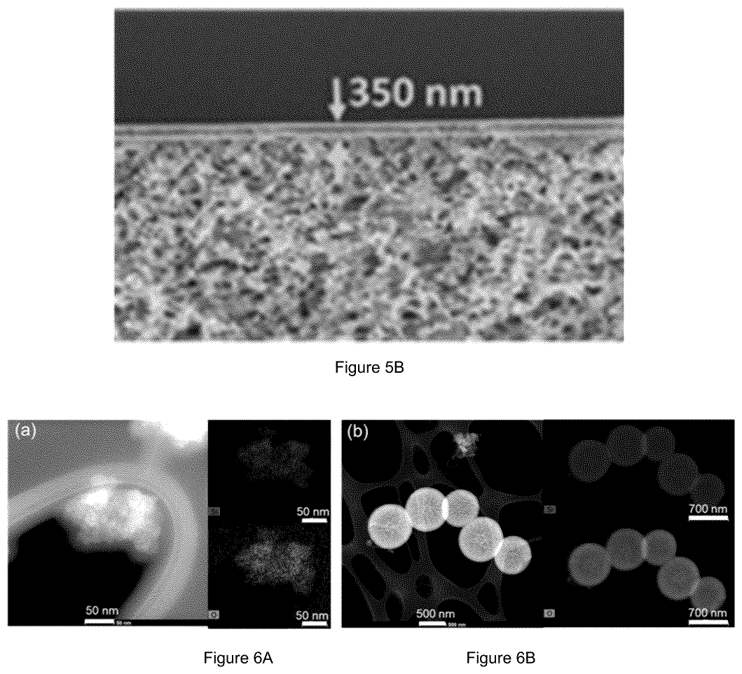

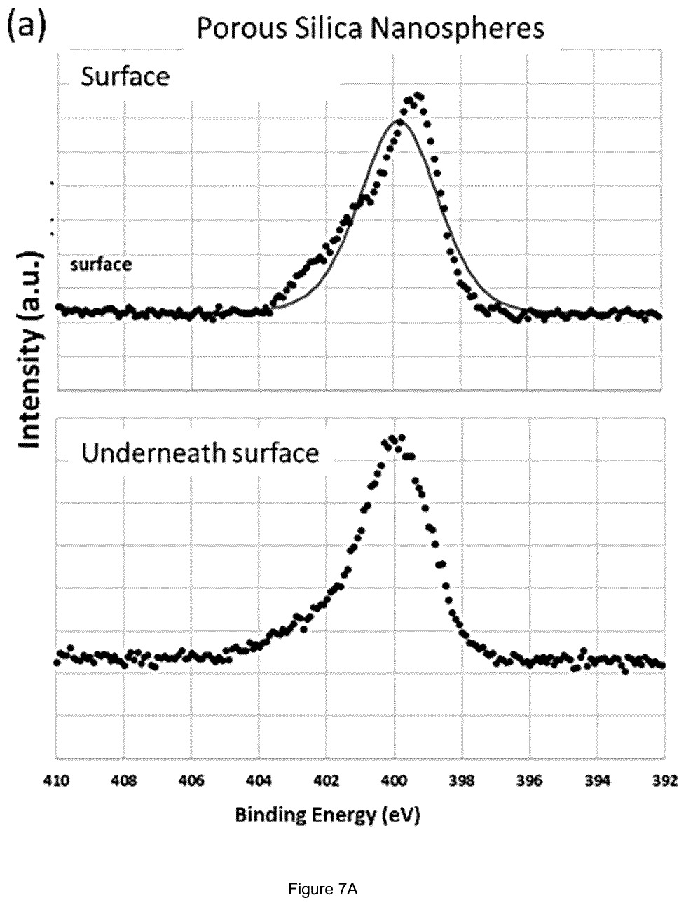

Amine-functionalized porous silica nanospheres can be fabricated as the immobile carrier, for example, using several techniques. For example, small silica nanospheres of less than 50 nm diameters were fabricated by emulsion templating of poly(acrylic acid) (PAA) by NH₄OH, followed by ethanol and tetraethyl orthosilicate (TEOS) treatment. FIG. 6A is a STEM-HAADF image and EDX elemental mapping of the as-formed nanospheres.

Larger silica nanospheres of size 500 nm were synthesized using cetrimonium bromide (CTAB) micelles. Firstly, CTAB was dissolved in a mixture of aqueous and ethanol solutions. Next, TEOS and ammonia were added sequentially. The mixture was then staged at moderate temperatures for extended hours (e.g., 6 h-8 h) for reaction. The nanospheres fabricated this way showed larger pore sizes as indicated by the STEM-HAADF images and EDX elemental mapping (FIG. 6B).

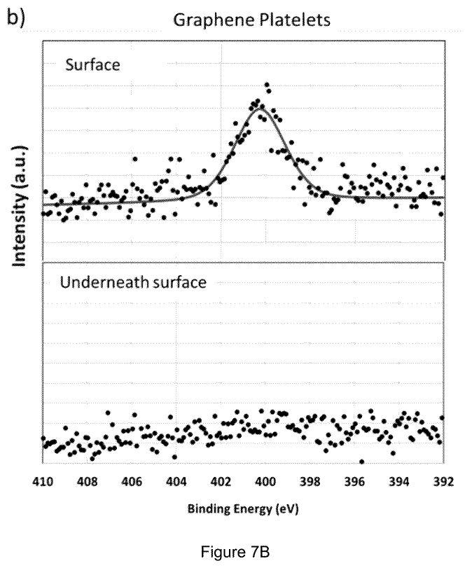

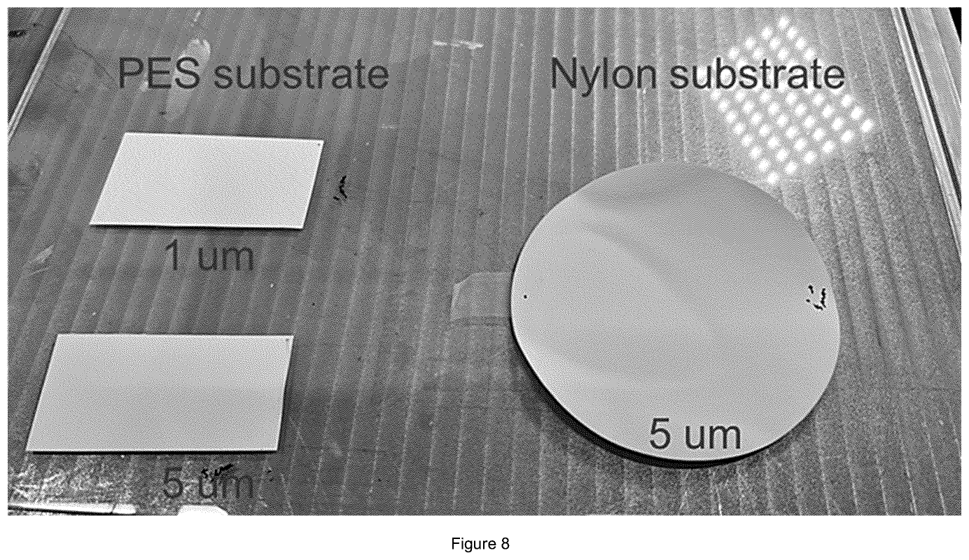

NH₂ functionalized SiO₂ nanosphere can be formed using one-step synthesis. For example, the addition of (3-Aminopropyl)triethoxysilane (APTES) in abovementioned method with CTAB can be used. Referring to FIG. 7A, XPS depth profiles of the nanospheres showed N 1s spectrum at around 400 eV, which is consistent with C—NH₂. This N 1s peak was observed both at surface and beneath surface, indicating NH₂-groups were introduced inside the pores. To confirm this, amine-functionalized graphene nanoplatelets were formed and measured. For the graphene samples, N 1s XPS peak was only detected at the surface but not underneath the skin (FIG. 7B), which is consistent with the non-porous microstructure of the graphene platelets. The advantage of the amine-functionalized porous structures is that these materials provide high amine density, which forms propylammonium carbamate ion pair [R—NH—COO][NH₃R] to facilitate CO₂ interaction. Low and high amine density leads to different CO₂ reaction mechanism. With a high amine density, proton transfer between carbamic acid and neighboring amine groups serves as a major CO₂ reaction mechanism. When amine density is low, isolated amines are present and form protonated species —R—NH—COOH. This feature provides design room to tailor membrane materials, compositions, and structures for various application needs.

Methods of the disclosure can allow coating widths of ≥0.3 m and lengths of more than several tens meters, making this a commercially viable process for producing membranes suitable for use in industrial manufacturing plants.

Membranes of the disclosure can be used in a variety of industrial processes in which CO₂ separation is beneficial. For example, the membranes can be utilized in cement production, steelmaking operation, chemical synthesis, refining, paper production, food production, core-fired power generation.

### EXAMPLES

### Example 1: Membrane with Amino Acid Salt Based CO₂-Philic Layer

Polyvinyl alcohol (PVA) and Proline with potassium (ProK) was prepared as a single composite CO₂-philic layer or a section of a bilayer composite CO₂-phillic layer. ProK was a mobile-CO₂ carrier. PVA was used as a polymer matrix to host ProK. An 8 wt % PVA water solution as prepared by dissolving PVA into deionized water at 80° for 4 hours. A precursor solution of 8% PVA-40% ProK was prepared by mixing 10 g of the 8 wt % PVA water solution with 0.533 g of L-proline and 0.259 KOH using a high-energy mixer operated at 3000 rpm for 10 min. KOH was added in an equal molar amount to L-proline. The percentage of ProK was calculated by following equation as 40%:

$$\% of ProK = \frac{{W}_{L - proline}}{{W}_{L - proline} + {W}_{PVA}}$$

A membrane having a single composite CO₂-philic layer with mobile and immobile carriers was fabricated from the precursor solution by coating the precursor solution on a commercially available porous PES membrane (served as the CO₂ permeance layer in this case). For samples 1 and 2, PES membranes purchased from BTS were used, which have an average pore size of 100 nm. For samples 3 and 4, a 3M 2F and a 3M 4F PES membrane was used, respectively. A slot-die coater with a 25 mm die-head was used for the coating of the CO₂-philic layer on the PES substrate directly or on PES substrate coated with a PDMS layer. The coating speed was controlled between 0.1-0.5 m/min, and the coating gap size was between 50-1000 μm, depending on the target CO₂ membrane thickness. A sample was also prepared using Nylon as the CO₂ permeance layer. FIG. 9 is a photograph as-prepared samples.

In samples 3 and 4, the CO₂-philic layer contains a PDMS bottom section and a Prok-PVA top section for the purpose of improving CO2 permeability. The PDMS precursor was prepared by mixing a PDMS base and a curing agent with a ratio of 10:1. Then the mixed PDMS base and curing agent was diluted with toluene to a composition of 75 wt % PDMS solution versus 25 wt % toluene. The coating of PDMS was performed using a slot-die coater with 100 mm die-head. After coating the PDMS film was aged at room temperature for 4-6 hours, followed by thermal curing at 60-85C for 2-4 hours. The dry PDMS layer thickness was 400 μm and 150 μm for sample 3 and 4, respectively Prok-PVA layers were then coated on top.

After the coating, membrane sample was dried at 60° C. (for sample 1 and 2) and 80° C. (for sample 3 and 4) for 1 hour, and evaluated its CO₂ separation performance. CO₂ permeability and CO₂/N₂ selectivity was measured at 1 atm using a continuous-flow gas permeation measurement system, where the concentration of the gases that permeate through the tested membranes will be measured directly using a gas chromatograph (GC). The feed gas is a CO₂—N₂ mixed gas comprising of 30% CO₂ and 70% N₂ purchased from Airgas. Additional water moisture was introduced to the feed gas during testing to promote the CO₂ reaction with the amine-based materials. The moisture content in the feed gas will be controlled by using a bubbler located in the temperature-controllable water bath, or by directly injecting moisture with a water vapor pump. Given the high solubility of CO₂ in water, the saturation of CO₂ in the bubbler will be maintained before measurement to ensure H₂O molecules are carried by the test gas. As for the pumping method, water vapor is generated using an evaporator. Table 1 shows the compositional features of the prepared membranes and the Table 2 shows the permeance, permeability and selectivity performance results.

TABLE 1

| | | CO₂-permeance | CO₂-philic |
|---|---|---|---|
| | | Layer | Layer |
| Sample | | Thickness | Thickness |
| No. | Composition | (μm) | (μm) |
| 1 | PES/8% PVA-40% ProK | 140 | 5 |
| 2 | PES/8% PVA-40% ProK | 140 | 10 |
| 3 | PES/PDMS-8% PVA-40% ProK | 110 | 400 |
| 4 | PES/PDMS-8% PVA-40% ProK | 110 | 150 |

TABLE 2

| | Permeance | | | | Permeability | | | | CO₂/N₂ | |
|---|---|---|---|---|---|---|---|---|---|---|
| | (GPU) | | | | (Barrer) | | | | selectivity | |
| Sample | N₂ | | CO₂ | | N₂ | | CO₂ | | dry | wet |
| No. | dry | wet | dry | wet | dry | wet | dry | wet | feed | feed |
| 1 | 1.99 | 0.053 | 1.82 | 9.05 | 19.9 | 0.5 | 18.2 | 90.6 | 0.92 | 171.3 |
| 2 | 0.36 | 0.041 | 0.38 | 6.94 | 1.82 | 0.2 | 1.9 | 34.7 | 1.1 | 169.6 |
| 3 | 0.11 | 0.14 | 0.82 | 5.23 | 21.9 | 27 | 164.7 | 1047.0 | 7.5 | 38.8 |
| 4 | 0.02 | 0.09 | Trace | 5.2 | 2.3 | 13.6 | — | 781.8 | — | 57.6 |

The samples in Table 1 have different PVA-Prok layer thickness and PDMS amount, which leads to different CO₂ permeability and selectivity. The results demonstrate high CO₂/N₂ selectivity of amino acid salt based membrane (e.g., 171) and by adjusting CO₂-philic layer structure, CO₂ permeability can be improved. The overall thickness of the CO₂-philic layer is high, reducing CO₂ permeance. Reducing CO₂-philic layer thickness or introducing porous nanostructures to improve CO₂ permeance is possible.

### Example 2. Membrane with Immobilized and Mobile CO₂ Carrier

Amine functionalized porous silica (NH₂—SiO₂) was incorporated into an amino acid salt containing PVA-ProK layer. The NH₂—SiO₂ was prepared in a one-step process for formation of the porous SiO₂ and NH₂-functionalization. Cetrimonium bromide (CTAB) was used as micelles template, and (3-Aminopropyl)triethoxysilane (APTES) was used as an agent for NH₂-functionalization. Specially, CTAB was first dissolved into 50 ml of ethanol/water mixture with ratio of 1:3. After the CTAB was fully dissolved, 0.5 ml of tetraethyl orthosilicate (TEOS) and 0.5 ml of ammonium hydroxide was added. Finally, 0.4934 g of APTES was added (molar ratio of TEOS:ATPES is 1:4). The resulting solution was kept at room temperature for 6 hours under the stirring. The white precipitation was collected by the centrifuge. The collected powder was washed with water and ethanol for 3 times and dried at 60° C. overnight.

A precursor solution with PVA, ProK, and NH₂—SiO₂ was prepared for coating as part of the CO₂-philic layer. The PVA solution was first prepared by dissolving 8 wt % PVA into DI water at 80° C. for 4 hours. 10 grams of this 8 wt % PVA solution was then mixed with 0.533 grams of L-proline and 0.259 grams of KOH. The KOH was added equal molar to L-proline, and percentage of ProK is calculated by the following equation as 40% of ProK:

$$\% of ProK = \frac{{W}_{L - proline}}{{W}_{L - proline} + {W}_{PVA}}$$

Then, 0.16 gram of NH₂—SiO₂ (i.e., 20 wt % of the mass of PVA) was added. The prepared precursor solution was fully dispersed using a high-energy mixer rotating at 2500 rpm for 30 min. This resulting solution was used to coat the top layer of the bilayer composite CO₂-philic layer having both mobile and immobile carriers.

The bottom layer of the bilayer CO₂-philic layer is a PDMS layer. PDMS precursor was prepared by mixing a PDMS base and a curing agent with a ratio of 10:1 and then diluting the mixture with toluene (25 wt % toluene vs. 75 wt % PDMS-based mixture). The PDMS solution was then coated on a porous commercial PES membrane (e.g., 3M 4F PES or BTS PES) by slot-die coating. For this particular sample, a 100 mm die-head was used. The coating speed was set between 0.1-0.5 m/min, and the coating gap was about 1000 μm. After coating, sample was aged at room temperature for 6-10 hours followed by oven curing at 60 C for 2-4 hours. The dry PDMS layer has 400 μm thicknesss.

After the PDMS layer is fully cured. An amine-functionalized polymer layer was coated on top of PDMS. Similar coating conditions were used to coat this layer, except that the coating gap was adjusted to obtain a thinner film. After the coating, the membrane sample was dried at 60° C. for 1 hour before CO₂ separation test. Dry film thickness of 5 μm was measured for the top amine-functionalized layer.

CO₂ permeability and CO₂/N₂ selectivity was measured at 1 atm using the same test conditions as described in Example 1. Table 3 shows the compositional features of the prepared membranes and the Table 4 shows the permeance, permeability and selectivity performance results.

TABLE 3

| | | CO₂-philic | Total |
|---|---|---|---|
| | | Layer | Membrane |
| Sample | | Thickness | Thickness |
| No. | Composition | (μm) | (μm) |
| 5 | PES/PDMS-8% PVA-40% | 405 | 405 |
| | ProK-20% NH₂—SiO₂ | | |

TABLE 4

| | Permeance | | | | Permeability | | | | CO₂/N₂ | |
|---|---|---|---|---|---|---|---|---|---|---|
| | (GPU) | | | | (Barrer) | | | | selectivity | |
| Sample | N₂ | | CO₂ | | N₂ | | CO₂ | | dry | wet |
| No. | dry | wet | dry | wet | dry | wet | dry | wet | feed | feed |
| 5 | 0.04 | 0.3 | 0.4 | 5.9 | 15.6 | 104.2 | 1436 | 2352.7 | 9.2 | 22.6 |

The results demonstrate that the addition of amine-functionalized porous silica nanospheres (NH₂—SiO₂) helps improve permeability.

### Aspects

Aspect 1. A CO₂ separation membrane, comprising:
a CO₂-philic layer comprising one or more mobile CO₂ carriers and one or more immobile CO₂ carriers, a blended CO₂-permeable and CO₂-selective polymer matrix, and water adsorption nanostructures; and
a CO₂-permeance layer, wherein the CO₂-philic layer is disposed upstream of the CO₂-permeance layer such that a flow of source gas to be separate enters the membrane from a feed side at which the CO₂-philic layer is present and CO₂ exits the membrane at a permeate side after passing through both the CO₂-philic layer and the CO₂-permeance layer.

Aspect 2. The membrane of aspect 1, wherein the CO₂-philic layer has a thickness of about 10 nm to about 500 μm.

Aspect 3. The membrane of aspect 1, wherein the water adsorption nanostructures comprise hollow nanostructures, or porous nanostructures, or molecular sieves.

Aspect 4. The membrane of aspect 1, wherein the blended CO₂-permeable and CO₂-selective polymer matrix comprise rubbery polymers, polyamine, poly(ionic liquid)-type materials, fluorinated polymers, glassy polymers, or blended matrix of those.

Aspect 5. The membrane of aspect 1, wherein the CO₂-permeance layer and the CO₂-philic layer are crosslinked by a polymer crosslinker.

Aspect 6. The membrane of aspect 5, wherein the crosslinker is trimethylolpropane tris(2-methyl-1-aziridinepropionate) (TATM), diethylenetriamine (DETA), triethylenetetramine (TETA), or perfluorinated toluene diisocyanate (PFTDI).

Aspect 7. The membrane of aspect 1 or 2, wherein the mobile CO₂ carriers comprise one or more amine-based mobile CO₂ carriers.

Aspect 8. The membrane of aspect 7, wherein the amine-based mobile CO₂ carriers comprise amine-containing small molecules, amino acid salts, amine-containing ionic liquids, and caronic anhydrase.

Aspect 9. The membrane of any one of the preceding aspects, wherein the one or more immobile CO₂ carriers are amine-impregnated hollow or porous nanostructures, molecular sieves, or certain amine-containing ionic liquids.

Aspect 10. The membrane of aspect 9, wherein the amine-containing ionic liquids are one or more of poly(1-vinyl-3-ethylimidazolium glycinate) (Poly([Veim] [Gyl]), Amine-crosslinked epoxide-amine poly(imidazolium) poly-[Im][TFSI]/1-ethyl-3-methylimidazolium dicyanamide ([EMIM] [DCA]).

Aspect 11. The membrane of aspect 9, wherein the nanostructures comprise one or more of porous silica nanospheres, porous TiO₂ nanoparticles, hollow oxides spheres, carbon nanotubes, graphene oxides, and molecular sieves such as zeolites, covalent organic frameworks and metal organic framework.

Aspect 12. The membrane of aspect 9 and 11, wherein the nanostructures have an effective average diameter of about 10 nm to about 1 μm, and a pore size or cavity size between 0.4 nm and 1 μm.

Aspect 13. The membrane of any one of aspects 9, 11 and 12, wherein the nanostructures are attached to a host matrix polymer.

Aspect 14. The membrane of aspect 13, wherein the nanostructures are attached to the matrix polymer through covalent linkage or tightly captured by the host polymers through host polymer crosslinking with crosslinker.

Aspect 15. The membrane of aspect 14, wherein covalent linkage is achieved by plasma surface modification, grafting functional polymer molecules, or silanization.

Aspect 16. The membrane of aspect 15, wherein functional molecules used for grafting or silanization comprises one or more materials selected from 3-glycidyloxypropyl trimethoxysilane (GPS), (3-Aminopropyl)triethoxysilane (APTES), Vinyltriethoxysilane (VTES), Phenyltrimethoxysilane (PTMS), and (3-Methacryloxypropyl)trimethoxysilane (MPS).

Aspect 17. The membrane of aspect 15, wherein the crosslinker that links the surface functionalized nanostructures and matrix is trimethylolpropane tris(2-methyl-1-aziridinepropionate) (TATM), diethylenetriamine (DETA), trimethylolpropane (TMP), trimethylolpropane trimethacrylate (TMPTMA), or hexamethylene diisocyanate (HDI).

Aspect 18. The membrane of aspect 4, 13, 14, wherein the matrix polymer is one or more of rubbery polymers, polyamine, poly(ionic liquid)-type materials, fluorinated polymers, glassy polymers, or blended matrix of those.

Aspect 19. The membrane of aspect 17, wherein the rubbery polymers is one or more of polydimethylsiloxane (PDMS) and polyamine/polyether elastomers such as Pebax® (ARKEMA), PVA, polybutadiene, and chloroprene polymers.

Aspect 20. The membrane of aspect 17, wherein the polyamine is one or more of polyvinylamine, poly(ethyleneimine), poly(allylamine), polyamidoamine dendrimer, and chitosan.

Aspect 21. The membrane of aspect 17 wherein the poly(ionic liquid)-type materials can include poly([Veim] [Gyl]), amine-crosslinked poly-[Im][TFSI] epoxy resin/[Emim] [DCA], tetrabutylphosphonium/-prolinate ([P₄₄₄₄][Pro]) and triethyl(2-methoxymethyl)phosphonium in-dazole ([P₂₂₂₁₀₁][Inda]).

Aspect 22. The membrane of aspect 17 wherein the fluorinated polymers can include fluoroelastomer, and polytetrafluoroethylene (PTFE)

Aspect 23. The membrane of aspect 17 wherein glassy polymers include aspoly(1-(trimethylsilyl)-1-propyne) (PTMSP)

Aspect 24. The membrane of any one of the preceding aspects, wherein the CO₂-philic layer has a gradient of concentration of one or both of the mobile and immobile CO₂ carriers.

Aspect 25. The membrane of aspect 23, wherein the CO₂-philic layer has a gradient of concentration of mobile CO₂ carriers with increasing concentration of the mobile CO₂ carriers from the feed side to the permeate side of the membrane.

Aspect 26. The membrane of aspect 23 or 24, wherein the CO₂-philic layer has a gradient concentration of immobile CO₂ carriers, with decreasing concentration of immobile CO₂ carriers from the feed side to the permeate side of the membrane.

Aspect 27. The membrane of aspect 25, wherein the CO₂-philic layer has a gradient concentration of mobile CO₂ carriers with increasing concentration of the mobile CO₂ carriers from the feed side to the permeate side of the membrane; and a gradient concentration of immobile CO₂ carriers, with decreasing concentration of immobile CO₂ carriers from the feed side to the permeate side of the membrane.

Aspect 28. The membrane of any one of aspects 1 to 22, wherein the CO₂-philic layer has a multi-layer structure comprising a first layer comprising the immobile CO₂ carriers and a second layer comprising the mobile CO₂ carriers, wherein the first layer is arranged at the feed side of the membrane and the second layer is downstream of the first layer.

Aspect 29. The membrane of any one of aspects 1 to 22, wherein the CO₂-philic layer has blended polymer materials and gradient compositions.

Aspect 30. The membrane of any one of the preceding aspects, wherein the CO₂-permeance layer is an anisotropic nanofiltration or ultrafiltration membrane.

Aspect 31. The membrane of any one of the preceding aspects, wherein the CO₂-permeance layer is one or more of polyethersulfone, polytetrafluoroethylene (PTFE), cellulose acetate, mixed cellulose ester (MCE) polycarbonate (PC), polyvinylidene fluoride (PVDF), and nylon.

Aspect 32. The membrane of any one of the preceding aspects, wherein the CO₂-permeance layer is ceramic.

Aspect 33. The membrane of aspect 32, wherein the ceramic is alumina (Al₂O₃), zirconia (ZrO₂), titania (TiO₂), silicon carbide (SiC), and glassy materials.

Aspect 34. The membrane of any one of the preceding aspects, wherein the CO₂-permeance layer comprises one or more metals and/or one or more metal alloys.

Aspect 35. The membrane of aspect 34, wherein the one or more metals and/metal alloys comprises one or more of aluminum, stainless steel, nickel-titanium, and alloys thereof.

Aspect 36. The membrane of any one of the preceding aspects, wherein the CO₂-permeance layer is a porous fibrous membrane.

Aspect 37. The membrane of any one of the preceding aspects, wherein the CO₂-permeance is non-planar and/or a hollow tubular structure.

Aspect 38. The membrane of any one of the preceding aspects, wherein the CO₂-permeance layer has a thickness of about 10 μm to about 1000 μm.

Aspect 39. The membrane of any one of the preceding aspects, wherein the CO₂-permeance layer is porous.

Aspect 40. The membrane of aspect 36 or 39, wherein the CO₂-permeance layer has an average pore size of about 1 nm to about 10 μm.

Aspect 41. The membrane of any one of the preceding aspects, further comprising a gutter layer arranged between the CO₂-philic layer and the CO₂-permeance layer.

Aspect 42. The membrane of aspect 41, wherein the gutter layer comprises one or more of rubbery polymers, polyamine, poly(ionic liquid)-type materials, fluorinated polymers, glassy polymers, and blends thereof.

Aspect 43. The membrane of aspect 33 or 34, wherein the gutter layer has a thickness of about 10 nm to about 500 μm.

Aspect 44. The membrane of any one of the preceding aspects, further comprising a cap layer disposed on the surface of the CO₂-philic layer.

Aspect 45. The membrane of aspect 44, wherein the cap layer comprises one or more of rubbery polymers, polyamine, poly(ionic liquid)-type materials, fluorinated polymers, glassy polymers, and blends thereof.

Aspect 46. The membrane of aspect 44 or 45, wherein the cap layer has a thickness of about 10 nm to about 5 μm.

Aspect 47. A method of making a membrane according to aspect 1, comprising coating a CO₂-philic precursor on a CO₂-permeance layer and drying or curing to form the CO₂-philic layer.

Aspect 48. The method of aspect 47, wherein the CO₂-philic precursor comprises both the immobile and mobile CO₂ carriers.

Aspect 49. The method of aspect 48, wherein the CO₂-philic precursor comprises a first precursor comprising mobile CO₂ carriers and a second precursor comprising immobile CO₂ carriers and the method comprises sequentially coating the CO₂-permeance layer with the second precursor and then coating with the first precursor to thereby form a multilayer CO₂-philic layer structure.

Aspect 50. The method of aspect 49, wherein the CO₂-philic precursor comprises a first precursor comprising mobile CO₂ carriers and a second precursor comprising immobile CO₂ carriers and the method comprises coating the CO₂-permeance layer with the first and second precursors such that the CO₂-philic layer has a gradient concentration of mobile CO₂ carriers with increasing concentration of the mobile CO₂ carriers from the feed side to the permeate side of the membrane; and/or a gradient concentration of immobile CO₂ carriers, with decreasing concentration of immobile CO₂ carriers from the feed side to the permeate side of the membrane.

The foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In the case of conflict, the present description, including definitions, will control.

Throughout the specification, where the compounds, compositions, methods, and/or processes are described as including components, steps, or materials, it is contemplated that the compounds, compositions, methods, and/or processes can also comprise, consist essentially of, or consist of any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

What is claimed is:

1. A CO₂ separation membrane, comprising:
a CO₂-philic layer comprising one or more mobile CO₂ carriers and one or more immobile CO₂ carriers, a blended CO₂-permeable and CO₂-selective polymer matrix, and water adsorption nanostructures; and
a CO₂-permeance layer, wherein the CO₂-philic layer is disposed upstream of the CO₂-permeance layer such that a flow of source gas to be separate enters the membrane from a feed side at which the CO₂-philic layer is present and CO₂ exits the membrane at a permeate side after passing through both the CO₂-philic layer and the CO₂-permeance layer.

2. The membrane of claim 1, wherein the CO₂-philic layer has a thickness of about 10 nm to about 500 μm.

3. The membrane of claim 1, wherein the water adsorption nanostructures comprise hollow nanostructures, or porous nanostructures, or molecular sieves.

4. The membrane of claim 1, wherein the blended CO₂-permeable and CO₂-selective polymer matrix comprise rubbery polymers, polyamine, poly(ionic liquid)-type materials, fluorinated polymers, glassy polymers, or blended matrix of those.

5. The membrane of claim 1, wherein the CO₂-permeance layer and the CO₂-philic layer are crosslinked by a polymer crosslinker comprising trimethylolpropane tris(2-methyl-1-aziridinepropionate) (TAT), diethylenetriamine (DETA), triethylenetetramine (TETA), or perfluorinated toluene diisocyanate (PFTDI).

6. The membrane of claim 1, wherein the mobile CO₂ carriers comprise one or more amine-based mobile CO₂ carriers, and the amine-based mobile CO₂ carriers comprise amine-containing small molecules, amino acid salts, amine-containing ionic liquids, and caronic anhydrase.

7. The membrane of claim 1, wherein the one or more immobile CO₂ carriers are amine-impregnated hollow or porous nanostructures, molecular sieves, or certain amine-containing ionic liquids.

8. The membrane of claim 7, wherein the amine-containing ionic liquids are one or more of poly(1-vinyl-3-ethylimidazolium glycinate) (Poly([Veim] [Gyl]), Amine-crosslinked epoxide-amine poly(imidazolium) poly-[Im][TFSI]/1-ethyl-3-methylimidazolium dicyanamide ([EMIM] [DCA]), and/or the nanostructures comprise one or more of porous silica nanospheres, porous TiO₂ nanoparticles, hollow oxides spheres, carbon nanotubes, graphene oxides, molecular sieves, covalent organic frameworks, and metal organic frameworks, and the nanostructures have an effective average diameter of about 10 nm to about 1 μm, and a pore size or cavity size between 0.4 nm and 1 μm.

9. The membrane of claim 8 wherein the nanostructures are attached to a host matrix polymer through covalent linkage or tightly captured by the host polymers through host polymer crosslinking with crosslinker.

10. The membrane of claim 9, wherein covalent linkage is achieved by plasma surface modification, grafting functional polymer molecules, or silanization, wherein the functional molecules used for grafting or silanization comprises one or more materials selected from 3-glycidyloxypropyl trimethoxysilane (GPS), (3-Aminopropyl)triethoxysilane (APTES), Vinyltriethoxysilane (VTES), Phenyltrimethoxysilane (PTMS), and (3-Methacryloxypropyl)trimethoxysilane (MPS), and wherein the crosslinker connecting functionalized nanostructures and matrix is selected from trimethylolpropane tris(2-methyl-1-aziridinepropionate) (TATM), diethylenetriamine (DETA), trimethylolpropane (TMP), trimethyiolpropane trimethacrylate (TMPTMA), or hexamethylene diisocyanate (HDI).

11. The membrane of claim 1, wherein the CO₂-permeable and CO₂-selective polymer matrix and/or the host matrix polymer is one or more of rubbery polymers, polyamine, poly(ionic liquid)-type materials, fluorinated polymers, glassy polymers, and blends thereof.

12. The membrane of claim 11, wherein:
the rubbery polymers comprise one or more of polydimethylsiloxane (PDMS), polyamine/polyether elastomers, PVA, polybutadiene, and chloroprene polymers, and/or
polyamine is one or more of polyvinylamine, poly(ethyleneimine), poly(allylamine), polyamidoamine dendrimer, and chitosan, and/or
the poly(ionic liquid)-type materials comprise one or more of poly([Veim] [Gyl]), amine-crosslinked poly-[Im][TFSI] epoxy resin/[Emim] [DCA], tetrabutylphosphonium I-prolinate ([P₄₄₄₄][Pro]) and triethyl(2-methoxymethyl)phosphonium in-dazole ([P₂₂₂₁₀₁][Inda]), and/or
the fluorinated polymers can include fluoroelastomer, and polytetrafluoroethylene (PTFE), and/or
the glassy polymers comprise aspoly(1-(trimethylsilyl)-1-propyne) (PTMSP)

13. The membrane of claim 1, wherein the CO₂-philic layer has a gradient of concentration of one or both of the mobile and immobile CO₂ carriers.

14. The membrane of claim 13, wherein the CO₂-philic layer has a gradient concentration of mobile CO₂ carriers with increasing concentration of the mobile CO₂ carriers from the feed side to the permeate side of the membrane; and a gradient concentration of immobile CO₂ carriers, with decreasing concentration of immobile CO₂ carriers from the feed side to the permeate side of the membrane.

15. The membrane of claim 1, wherein the CO₂-philic layer has a multi-layer structure comprising a first layer comprising the immobile CO₂ carriers and a second layer comprising the mobile CO₂ carriers, wherein the first layer is arranged at the feed side of the membrane and the second layer is downstream of the first layer.

16. The membrane of claim 1, wherein the CO₂-philic layer has blended polymer materials and gradient compositions.

17. The membrane of claim 1, wherein the CO₂-permeance layer is an anisotropic nanofiltration or ultrafiltration membrane and/or is a porous fibrous membrane, and/or wherein the CO₂-permeance layer is:
one or more of polyethersulfone, polytetrafluoroethylene (PTFE), cellulose acetate, mixed cellulose ester (MCE) polycarbonate (PC), polyvinylidene fluoride (PVDF), and nylon; or
a ceramic comprising one or more of alumina (Al₂O₃), zirconia (ZrO₂), titania (TiO₂), silicon carbide (SiC), and glassy materials, or
a metal or metal alloy comprising one or more of aluminum, stainless steel, nickel-titanium, and alloys thereof; and/or wherein the CO₂-permeance layer.

18. The membrane of claim 1, further comprising a gutter layer arranged between the CO₂-philic layer and the CO₂-permeance layer and/or a cap layer disposed on the surface of the CO₂-philic layer.

19. A method of making a membrane according to claim 1, comprising coating a CO₂-philic precursor on a CO₂-permeance layer and drying or curing to form the CO₂-philic layer.

20. The method of claim 19, wherein:
the CO₂-philic precursor comprises a first precursor comprising mobile CO₂ carriers and a second precursor comprising immobile CO₂ carriers and the method comprises sequentially coating the CO₂-permeance layer with the second precursor and then coating with the first precursor to thereby form a multilayer CO₂-philic layer structure, or
the CO₂-philic precursor comprises a first precursor comprising mobile CO₂ carriers and a second precursor comprising immobile CO₂ carriers and the method comprises coating the CO₂-permeance layer with the first and second precursors such that the CO₂-philic layer has a gradient concentration of mobile CO₂ carriers with increasing concentration of the mobile CO₂ carriers from the feed side to the permeate side of the membrane; and/or a gradient concentration of immobile CO₂ carriers, with decreasing concentration of immobile CO₂ carriers from the feed side to the permeate side of the membrane.
